(19) United States
(12) Patent Application Publication
(10) Pub. No.: US 2013/0333384 A1
(43) Pub. Date: Dec. 19, 2013

(54) SOLAR POWER SYSTEM AND SOLAR ENERGY COLLECTION DEVICE THEREOF

(71) Applicant: INDUSTRIAL TECHNOLOGY RESEARCH INSTITUTE, Hsinchu (TW)

(72) Inventors: Ming-Chieh CHOU, Tainan City (TW); Pin CHANG, Hsinchu City (TW); Yi-Cheng CHEN, New Taipei City (TW); Yu-Jen WANG, Tainan City (TW); Chien-Shien YEH, Tainan City (TW)

(73) Assignee: INDUSTRIAL TECHNOLOGY RESEARCH INSTITUTE, Hsinchu (TW)

(21) Appl. No.: 13/725,155

(22) Filed: Dec. 21, 2012

(30) Foreign Application Priority Data
Jun. 13, 2012 (TW) 101121058

(51) Int. Cl. F03G 7/00

(52) U.S. Cl. CPC F03G 7/00
USPC 60/641.8

(57) ABSTRACT

A solar energy connection device is provided, including a C-shaped reflecting plate, a heat pipe and a wing-shaped structure. The C-shaped reflecting plate includes a parabolic surface defining a symmetrical axis and a focusing axis. The heat pipe is disposed on the focusing axis of the parabolic surface with a working fluid flowing therein. The wing-shaped structure connects to the heat pipe and extends outwardly from the heat pipe, wherein the extension direction of the wing-shaped structure is parallel to the symmetrical axis.

### CROSS REFERENCE TO RELATED APPLICATIONS

The present application is based on, and claims priority from, Taiwan Patent Application No. 101121058, filed on Jun. 13, 2012, the disclosure of which is hereby incorporated by reference herein in its entirety.

### TECHNICAL FIELD

The disclosure relates to a solar energy collection device and a solar power system.

### BACKGROUND

Solar energy collection devices commonly focus light on a heat pipe through a condenser to heat a working fluid flowing in the heat pipe. Thus, heat can be transferred to a thermoelectric device by the working fluid and transformed into electrical energy for storage or usage. As the surface of the heat pipe is smaller relative to the parabolic surface of the condenser, and the sun moves in the sky over time, the condenser requires a precise and adjustable sun tracking device to continuously focus light on the heat pipe. Nevertheless, while deviations occur in the sun tracking angle, the light may depart from the surface of the heat pipe to reduce the efficiency of light collection.

### SUMMARY

A solar energy collection device is provided, comprising a C-shaped reflecting plate, a heat pipe, and at least one wing-shaped structure. The C-shaped reflecting plate comprises a parabolic surface defining a symmetrical axis and a focusing axis. The symmetrical axis and the focusing axis are perpendicular to each other and define a symmetrical plane. The symmetrical axis and the focusing axis are on the symmetrical plane. The heat pipe is disposed on the symmetrical plane and forms a tubular body with a working fluid flowing therein. The wing-shaped structure is connected to the heat pipe and is extended outwardly from the heat pipe, wherein the extension direction of the wing-shaped structure is parallel to the symmetrical plane.

A solar power system is further provided, comprising the solar energy collection device, a heat storage device, and a thermoelectric device. The heat storage device is connected to the solar energy collection device. The solar energy collection device transfers heat to the heat storage device by the working fluid. The thermoelectric device is connected to the heat storage device and the solar energy collection device for transforming heat in the heat storage device into electrical energy.

A solar energy collection device is provided, comprising a C-shaped reflecting plate, a heat pipe, and two wing-shaped structures. The C-shaped reflecting plate comprises a parabolic surface defining a symmetrical axis and a focusing axis. The symmetrical axis and the focusing axis are perpendicular to each other and define a symmetrical plane, wherein the symmetrical axis and the focusing axis are on the symmetrical plane. The heat pipe is disposed on the focusing axis and forms a tubular body with a working fluid flowing therein. The two wing-shaped structures are respectively connected to opposite sides of the heat pipe and extend in two opposite directions, wherein the two opposite directions are parallel to the symmetrical plane.

### BRIEF DESCRIPTION OF DRAWINGS

The application can be more fully understood by reading the subsequent detailed description and examples with references made to the accompanying drawings, wherein:

FIG. 1 is a schematic diagram of a solar energy collection device according to an embodiment of the disclosure.

FIG. 2 is a sectional view of a heat pipe and two wing-shaped structures according to an embodiment of the disclosure.

FIG. 3 is a sectional view of a heat pipe and two wing-shaped structures according to another embodiment of the disclosure.

FIG. 4 is an enlarged view of part A in FIG. 3.

FIGS. 5, 6A, and 6B are schematic diagrams of a solar energy collection device according to different embodiments of the disclosure.

FIG. 7 is a schematic diagram of a solar power system according to an embodiment of the disclosure.

### DETAILED DESCRIPTION OF DISCLOSED EMBODIMENTS

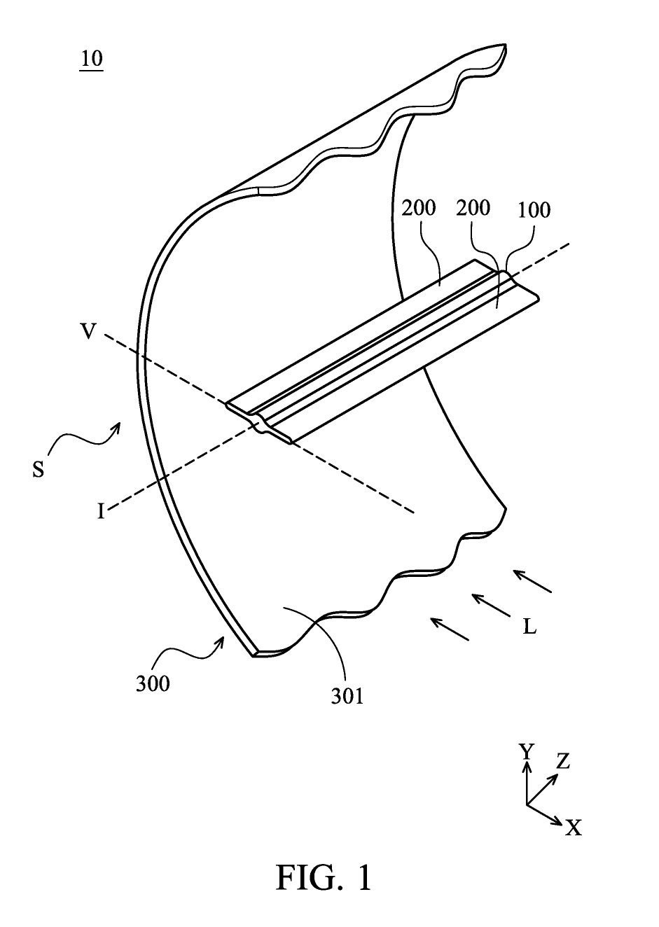

Referring to FIG. 1, an embodiment of a solar energy collection device 10 comprises a C-shaped reflecting plate 300, a heat pipe 100, and at least one wing-shaped structure 200. The C-shaped reflecting plate 300 comprises a parabolic surface 301 defining a symmetrical axis V and a focusing axis I perpendicular to each other, wherein the symmetrical axis V and the focusing axis I are on a symmetrical plane S. The heat pipe 100 is extended along the focusing axis I of the parabolic surface 301 (parallel to the Z axis). Two wing-shaped structures 200 are connected to the heat pipe 100 and extended in opposite directions (X and −X directions), wherein the extension directions of the wing-shaped structures 200 are parallel to the symmetrical plane S of the parabolic surface 301. That is, the two wing-shaped structures 200 are symmetrically connected to opposite sides of the heat pipe 100. The heat pipe 100 is disposed on the focusing axis I of the C-shaped reflecting plate 300, and the two wing-shaped structures 200 are situated on the symmetrical surface S. The two wing-shaped structures 200 are approximately perpendicular to or perpendicular to the parabolic surface 301 of the C-shaped reflecting plate 300. The C-shaped reflecting plate 300 defines a bending plate to form a concave plate. The concave plate may be a parabolic surface of the plate.

The parabolic surface 301 on an inner side of the C-shaped reflecting plate 300 can reflect and focus light L on the heat pipe 100 and the wing-shaped structures 200, to heat the working fluid in the heat pipe 100. The incident light L is substantially parallel to the X direction, and the wing-shaped structures 200 can increase the light collection area of the solar energy collection device 10. Thus, the light L can be efficiently projected on the heat pipe 100 and the wing-shaped structure 200 for heat collection.

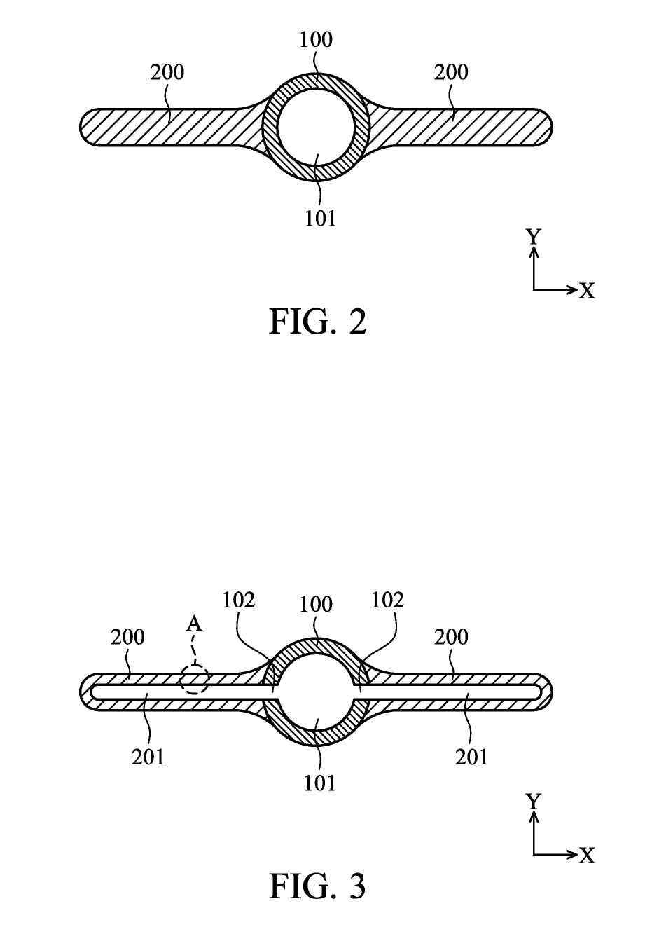

Referring to FIG. 2, in this embodiment, the two wing-shaped structures are symmetrically connected to opposite sides of the heat pipe 100 for transferring heat to the working fluid in a tubular body 101 of the heat pipe 100.

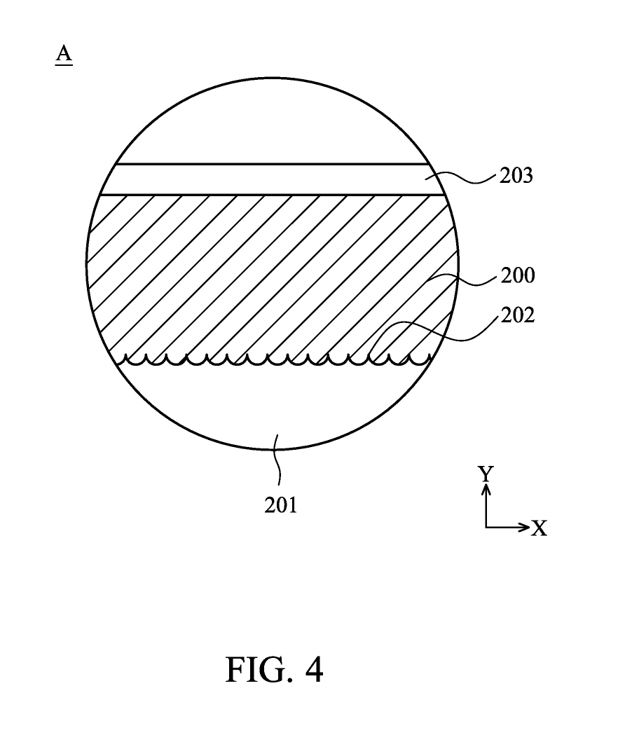

In another embodiment, the wing-shaped structure 200 forms a cavity 201 (show as FIG. 3) that communicates with the tubular body 101 of the heat pipe 100. The working fluid can flow through the cavity 201 and the tubular body 101 of the heat pipe 100 to take away heat from the heat pipe 100 and the wing-shaped structure 200.

The two wing-shaped structures 200 can be respectively connected to opposite sides of the heat pipe 100 by soldering or integrally formed in one piece with the heat pipe 100, as shown in FIG. 2. Soldering is one of the methods but it is not intended to limit the scope of the disclosure. Referring to FIG. 3, the heat pipe 100 includes two holes 102, and each of the wing-shaped structures 200 includes a concaved cavity 201. During assembly, the opening cavities 201 and the holes 102 can be aligned and made to communicate with each other by soldering. One end of the heat pipe 100 is sealed, and the other end is vacuumed by a vacuum device and sealed to form the heat pipe.

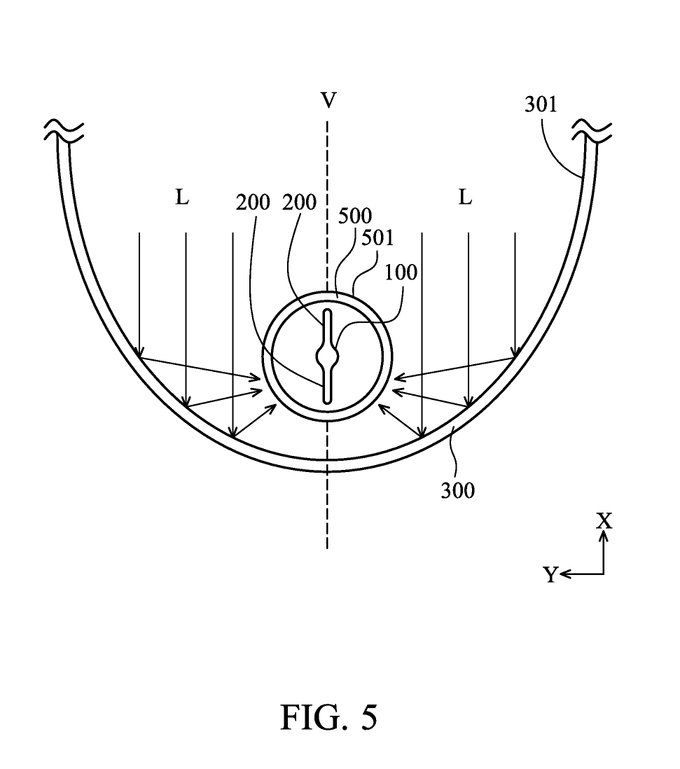

FIG. 4 is an enlarged view of part A in FIG. 3. In this embodiment, the inner side of the heat pipe 100 and the inner side of the cavity 201 of the wing-shaped structure 200 form a capillary structure 202 to increase the contact area between the heat pipe 100, the wing-shaped structure 200 and the working fluid, thus improving the heat transfer efficiency and accelerating the flow rate of the working fluid. The capillary structure 202 may comprise a metal mesh structure or a groove structure. Furthermore, a composite material 203 is formed on the wing-shaped structure 200. The composite material 203 can absorb heat and facilitate the heat collection of the wing-shaped structure 200. The composite material may comprise Mo—Al₂O₃, W—Al₂O₃, or Ni—Al₂O₃.

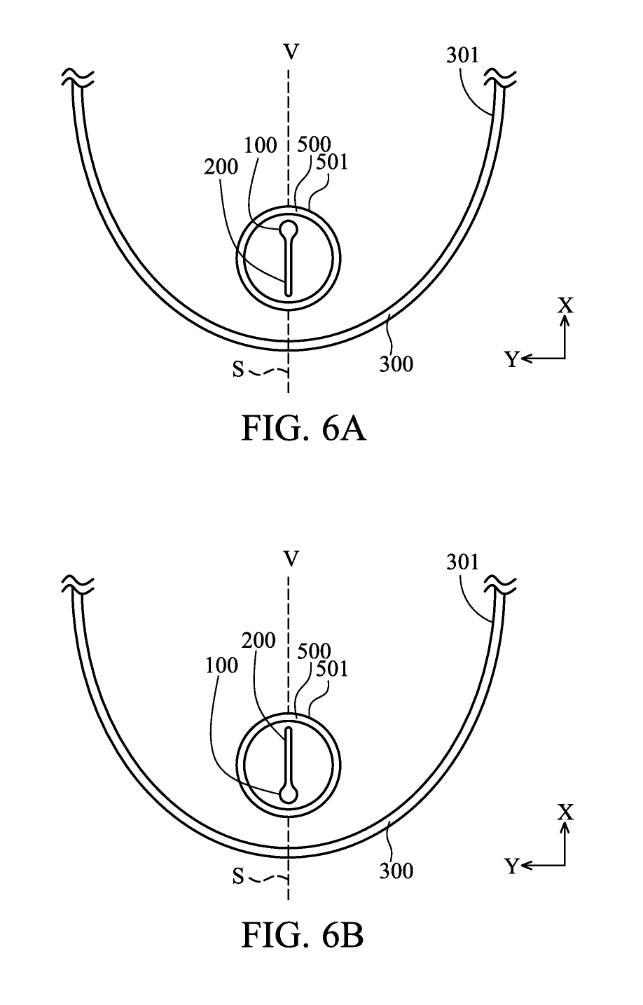

Referring to FIG. 5, another embodiment of a solar energy collection device 10 further comprises a transparent tube 500, wherein light L reflected by the parabolic surface 301 can pass through the transparent tube 500 to the heat pipe 100 and the wing-shaped structures 200, wherein the transparent tube 500 may comprise glass. The wing-shaped structures 200 and the heat pipe 100 are received in the transparent tube 500, as shown in FIG. 5, wherein the transparent tube 500 may be vacuumed to prevent the heat loss due to heat conduction. Additionally, an optical coating 501 may be formed on the transparent tube 500, and the transparent tube 500 may comprise MgF₂, thus allowing light L with specific range of frequency to pass therethrough and increasing the utility efficiency of the light L. The transparent tube 500 may also be fixed to the heat pipe 100 with the wing-shaped structures 200 received in the transparent tube 500.

When the incident light L is not parallel to the symmetrical axis V of the parabolic surface 301 and an inclined angle is formed in between the incident light L and the symmetrical axis V, most of the light L can still be collected by the wing-shaped structure 200 extended outwardly from the heat pipe 100. Thus, stable and high-efficiency light collection can be achieved even when the incident light L is not parallel to the symmetrical axis V. However, the size and configuration of the solar energy collection device 10 can still be modified according to practical requirements to have the best efficiency of light collection.

Referring to FIGS. 6A, and 6B, an embodiment of a solar energy collection device 10 may comprises a single wing-shaped structure 200 connected to a heat pipe 100 and extended in the X direction (FIG. 6A) or −X direction (FIG. 6B), wherein the extension direction of the wing-shaped structure 200 is parallel to the symmetrical plane S of the parabolic surface 301. The structural center of the heat pipe 100 and the wing-shaped structure 200 is on the focusing axis I, so that most of the light L can be efficiently collected by the solar energy collection device 10.

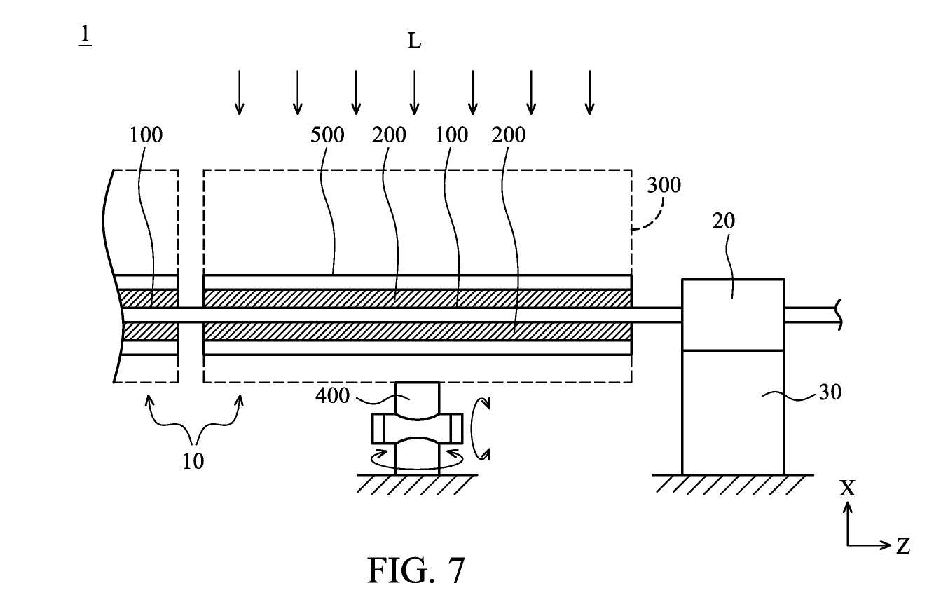

Referring to FIG. 7, the application further provides a solar power system 1 comprising at least one solar energy collection device 10, a heat storage device 20, and a thermoelectric device 30. The heat storage device 20 may be molten salt heat storage, and the thermoelectric device 30 may comprise a heat engine, steam turbine, or thermoelectric material. The solar energy collection device 10 can transfer heat to the heat storage device 20 for storage by the working fluid in the heat pipe 100, and the thermoelectric device 30 connects the heat storage device 20 with the solar energy collection device 10 for transforming heat into electrical energy. In some embodiments, a plurality of solar energy collection devices 10 may be serially connected to each other, forming a solar energy collection device array to improve efficiency of the solar energy collection devices 10.

As shown in FIG. 7, the solar energy collection device 10 is installed on a rotatable sun tracking device 400, wherein the angle of the solar energy collection device 10 can be adjusted according to the position of the sun in the sky. As the solar energy collection device 10 has at least one wing-shaped structure 200 extending from the heat pipe 100, high-efficiency light collection can be achieved even when a light collection angle deviation occurs. Thus, expensive positioning devices and frequent operation of the sun tracking device 400 can be avoided to reduce product cost.

While the application has been described by way of example and in terms of preferred embodiment, it is to be understood that the application is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A solar energy collection device, comprising:
a C-shaped reflecting plate, comprising a parabolic surface defining a symmetrical axis and a focusing axis, wherein the symmetrical axis and the focusing axis are perpendicular to each other and define a symmetrical plane, wherein the symmetrical axis and the focusing axis are on the symmetrical plane;
a heat pipe, disposed on the symmetrical plane and forming a tubular body with a working fluid flowing therein; and
at least one wing-shaped structure, connected to the heat pipe and extended outwardly from the heat pipe, wherein an extension direction of the wing-shaped structure is parallel to the symmetrical plane.

2. The solar energy collection device as claimed in claim 1, wherein the solar energy collection device further comprises a transparent tubular body with the wing-shaped structure and the heat pipe disposed therein.

3. The solar energy collection device as claimed in claim 2, wherein the transparent tubular body is vacuumed.

4. The solar energy collection device as claimed in claim 2, wherein the transparent tubular body comprises glass.

5. The solar energy collection device as claimed in claim 2, wherein the solar energy collection device further comprises an optical coating formed on the transparent tubular body.

6. The solar energy collection device as claimed in claim 5, wherein the transparent tubular body comprises MgF₂.

7. The solar energy collection device as claimed in claim 1, wherein the heat pipe and the wing-shaped structure are integrally formed in one piece or connected to each other by soldering.

8. The solar energy collection device as claimed in claim 1, wherein the solar energy collection device further comprises a composite material formed on the wing-shaped structure for absorbing heat.

9. The solar energy collection device as claimed in claim 8, wherein the composite material comprises Mo—Al₂O₃, W—Al₂O₃ or Ni—Al₂O₃.

10. The solar energy collection device as claimed in claim 1, wherein the wing-shaped structure includes a cavity that communicates with the tubular body of the heat pipe.

11. The solar energy collection device as claimed in claim 10, wherein the cavity and the tubular body of the heat pipe form a capillary structure.

12. A solar power system is provided, comprising:
a solar energy collection device as claimed in claim 1;
a heat storage device, connected to the solar energy collection device, wherein the solar energy collection device transfers heat to the heat storage device by the working fluid; and
a thermoelectric device, connected to the heat storage device and the solar energy collection device for transforming heat in the heat storage device into electrical energy.

13. The solar power system as claimed in claim 12, wherein the heat storage device is molten salt heat storage and the thermoelectric device comprises a heat engine, steam turbine, or thermoelectric material.

14. A solar energy collection device, comprising:
a C-shaped reflecting plate, comprising a parabolic surface defining a symmetrical axis and a focusing axis, wherein the symmetrical axis and the focusing axis are perpendicular to each other and define a symmetrical plane, wherein the symmetrical axis and the focusing axis are on the symmetrical plane;
a heat pipe, disposed on the focusing axis and forming a tubular body with a working fluid flowing therein; and
two wing-shaped structures, respectively connected to opposite sides of the heat pipe and extended in two opposite directions, wherein the two opposite directions are parallel to the symmetrical plane.
